(19) United States
(12) Patent Application Publication
(10) Pub. No.: US 2021/0118010 A1
(43) Pub. Date: Apr. 22, 2021

(54) SYSTEM AND METHOD FOR CONTACT MATCHING FOR MARKETING CAMPAIGNS

(71) Applicant: Introhive Services Inc., Fredericton (CA)

(72) Inventors: Jennifer LANDRY, Oromocto (CA); David HUDSON, Fredericton (CA)

(21) Appl. No.: 17/073,291

(22) Filed: Oct. 16, 2020

Related U.S. Application Data
(60) Provisional application No. 62/915,949, filed on Oct. 16, 2019.

(51) Int. Cl. G06Q 30/02

(52) U.S. Cl. CPC G06Q 30/0269; G06Q 30/0277; G06Q 30/0201

(57) ABSTRACT

Computer implemented method and system that includes storing campaign data for a marketing campaign that includes one or more marketing activities, the campaign data including a target contact demographic profile that defines a set of target attributes in respect of a target contact for the campaign; retrieving, from a database, contact data for a plurality of contacts, the contact data for each of the contacts including contact attributes of the same type that are included in the set of target attributes; computing, based on a comparison of the set of target attributes and the contact attributes for the plurality of contacts, a subset of the contacts suitable for the marketing campaign; and storing information identifying the subset of contacts in a participant list for the marketing campaign.

### CROSS-REFERENCE TO RELATED APPLICATION

This application claims the benefit of and priority to the following application, the contents of which are incorporated herein by reference: U.S. Provisional Patent Application No. 62/915,949 entitled “System and Method for Contact Matching for Marketing Campaigns filed on Oct. 16, 2019”.

### TECHNICAL FIELD

The present disclosure relates to automated systems and methods for data analysis for matching marketing campaigns with individual contacts.

### BACKGROUND

Enterprises such as companies, accounting firms, law firms, universities, partnerships, agencies and governments commonly use customer relationship management (CRM) systems and related technology to manage relationships, interactions and opportunities with other parties such as customers, and potential customers.

Marketing campaigns are often used by enterprises to promote and sell a product or service. A marketing campaign may include one or more targeted actions or events, for example interactive events such as webinars, thought leadership sessions, or social/networking events like a dinner or harbor cruise; communication events such as a targeted emailing; or targeted promotional give-away events. In at least some cases, marketing campaigns may be targeted based on lists of individuals that have been compiled by a campaign creator that is a member of a sales and/or marketing department. The target lists of contacts for a marketing campaign could for example be directed to people having certain positions, who are located in certain geographic jurisdictions, or who are perceived as having an interest in a specific industry. For example, one marketing campaign may be targeted to CFO's in Dallas, Tex. that are in the pharmaceutical industry; a further marketing campaign may be targeted at people interested in hearing anything related to regulations on crypto currency; and a further marketing campaign may simply be directed to a list of people the enterprise wants to send something physical to (such as but not limited to Christmas cards, a company branded golf shirt or a product brochure).

Currently, marketing campaigns have a challenge including all of the contacts that would be appropriate for the campaign. The larger the organization, the more difficult this challenge is as personal knowledge of the marketing campaign creators cannot accurately encompass all of an enterprise's contacts.

For example, when a marketing campaign is created, there is an intended audience for that campaign. The campaign creators create a list of contacts for the campaign but may not be aware of all of the appropriate contacts that would be beneficial to be included in the campaign.

Furthermore, situations can arise where a representative of an enterprise has a relationship with a contact that has not been included in an existing marketing campaign and that representative wants to add the contact to a suitable marketing campaign.

Matching of individual contacts to marketing campaigns can be highly inaccurate and time consuming and rely extensively on personal knowledge.

The foregoing examples of the related art and limitations thereto are intended to be illustrative and not exclusive. Other limitations of the related art will become apparent to those of skill in the art upon a reading of the specification and a study of the drawing.

### SUMMARY

According to a first example aspect is a computer implemented method that includes storing campaign data for a marketing campaign that includes one or more marketing activities, the campaign data including a target contact demographic profile that defines a set of target attributes in respect of a target contact for the campaign; retrieving, from a database, contact data for a plurality of contacts, the contact data for each of the contacts including contact attributes of the same type that are included in the set of target attributes; computing, based on a comparison of the set of target attributes and the contact attributes for the plurality of contacts, a subset of the contacts suitable for the marketing campaign; and storing information identifying the subset of contacts in a participant list for the marketing campaign.

In some examples, the method includes, retrieving from the database, contact data for a subject contact, the contact data for the subject contact including a set of subject contact attributes; retrieving the stored campaign data for a plurality of marketing campaigns, the stored campaign data including the set of target attributes for each of the marketing campaigns; computing based on a comparison of the set of target attributes for the plurality of marketing campaigns, a subset of the marketing campaigns that are suitable for the subject contact; and presenting information identifying the subset of the marketing campaigns.

According to a further example embodiment is a system for matching marketing campaigns and contacts, the system comprising a processor and non-transitory storage medium coupled to the processor, the storage medium storing software instructions that when executed by the processor configure the system to: store campaign data for a marketing campaign that includes one or more marketing activities, the campaign data including a target contact demographic profile that defines a set of target attributes in respect of a target contact for the campaign; retrieve, from a database, contact data for a plurality of contacts, the contact data for each of the contacts including contact attributes of the same type that are included in the set of target attributes; compute, based on a comparison of the set of target attributes and the contact attributes for the plurality of contacts, a subset of the contacts suitable for the marketing campaign; and store information identifying the subset of contacts in a participant list for the marketing campaign.

### BRIEF DESCRIPTION OF DRAWINGS

Example embodiments are illustrated in the referenced Figures of the drawings. It is intended that the embodiments and Figures disclosed herein are to be considered illustrative rather than restrictive.

FIG. 1 is a simplified block diagram illustrating an environment that includes an enterprise network, CRM system, and a CRM support system in accordance with example embodiments of the present disclosure.

FIG. 2 illustrates steps taken during creation of a marketing campaign, according to example embodiments.

FIG. 3 illustrates an example of a user interface form that may be used to define attributes of a marketing campaign.

FIG. 4 illustrates steps taken to match a contact to an existing marketing campaign.

FIG. 5 illustrates an example of a user interface form that may be used to present recommended marketing campaigns for a contact.

FIG. 6 illustrates an example of a user interface form that may be used to modify marketing campaign priorities when matching a contact.

FIG. 7 illustrates a block diagram of a computer system that can be configured to implement one or more processes and features of the methods and systems described.

### DESCRIPTION

Example embodiments will now be described more fully hereinafter with reference to the accompanying drawings, in which some, but not all, embodiments of the invention are shown. The features and aspects presented in this disclosure may be embodied in many different forms and should not be construed as limited to the embodiments set forth herein. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Example embodiments are directed to computer implemented systems and methods for identifying contacts to be included in marketing campaigns by utilizing a relationship database and contact information from a CRM. Example embodiments of automated methods and systems are disclosed that collect and analyze information from various sources to compute matches between contacts and marketing campaigns. In at least some example embodiments, the automated methods and systems disclosed herein may improve the accuracy of information that can be generated by a computer system. In at least some example embodiments, the automated methods and systems disclosed herein may reduce the amount of interaction required between computer systems, and/or between an individual user and one or more computer systems, than might otherwise be required using existing data analysis solutions. This may in turn reduce the computational resources and/or use (and thus wear-and-tear and depreciation) of user-computer interfaces and/or user resources that could otherwise be required in the absence of the presently disclosed solutions.

Example embodiments are directed to computer implemented systems and methods for matching currently active marketing campaigns with a specific contact. The determination of appropriate marketing campaigns is assisted by a weighting of campaign attributes to find appropriate recommendations.

In example embodiments, a campaign creator setting up a targeted marketing campaign, based on marketing campaign target contact attributes (such as, but not limited to, attributes such as contact's location, industry, company size, title score, department, strength of relationship, current customer status, and past engagement with marketing campaign events) will be provided with a suggested list of contacts that should be included in or targeted by the marketing campaign.

An example of this would be, but not limited to, the enterprise has created a new marketing campaign having a primary event that will be held in Dallas, Tex. for pharmaceutical company managers. The campaign creator creates a target list that includes 7 contacts that they know, based on personal knowledge, fit the demographic of targets for the marketing campaign. A marketing campaign recommendation module may provide the campaign creator with a suggested list of 12 contacts based on information included in a relationship database that would fit the target contact demographic of the marketing campaign. From this list, the campaign creator would decide to extend additional invitations.

In example embodiments, an enterprise employee with a relationship to a contact may interact with a marketing campaign recommendation module to view existing marketing campaigns to see which campaigns, if any, has matching attributes to their client. The enterprise employee checks available marketing campaigns with attributes that match the contact. The enterprise employee can then add the contact to the target list for one of the marketing campaigns. If the enterprise employee does not feel any of the provided marketing campaign matches are what their contact may benefit from at this time, then they may expand the search by adjusting the weight of the marketing campaign attributes and the present embodiment will provide a list of existing marketing campaigns based on the adjusted weights of the attributes.

An example of this would be, but not limited to, the enterprise employee has a contact that they are communicating with in the pharmaceutical industry to determine if there is an opportunity to conduct business. The enterprise employee would like to find a marketing campaign that can assist in providing additional information for their contact, in hopes of securing business with the contact's company. The enterprise employee utilizes an example embodiment and is presented with no matching marketing campaigns. The enterprise employee then adjusts matching criteria by lowering the priority given to industry (as they want their contact to have a general knowledge of the product) and decides that non-industry specific information would be sufficient. The marketing campaign recommendations then returns marketing campaign that includes an introductory webinar designed for the oil and gas industry. The enterprise employee recommends this to their contact, who agrees that specific industry information in an introduction would not be a detriment for them.

Throughout the following description, specific details are set forth in order to provide a more thorough understanding to persons skilled in the art. However, well known elements may not have been shown or described in detail to avoid unnecessarily obscuring the disclosure. Accordingly the description and drawings are to be regarded in an illustrative, rather than a restrictive, sense.

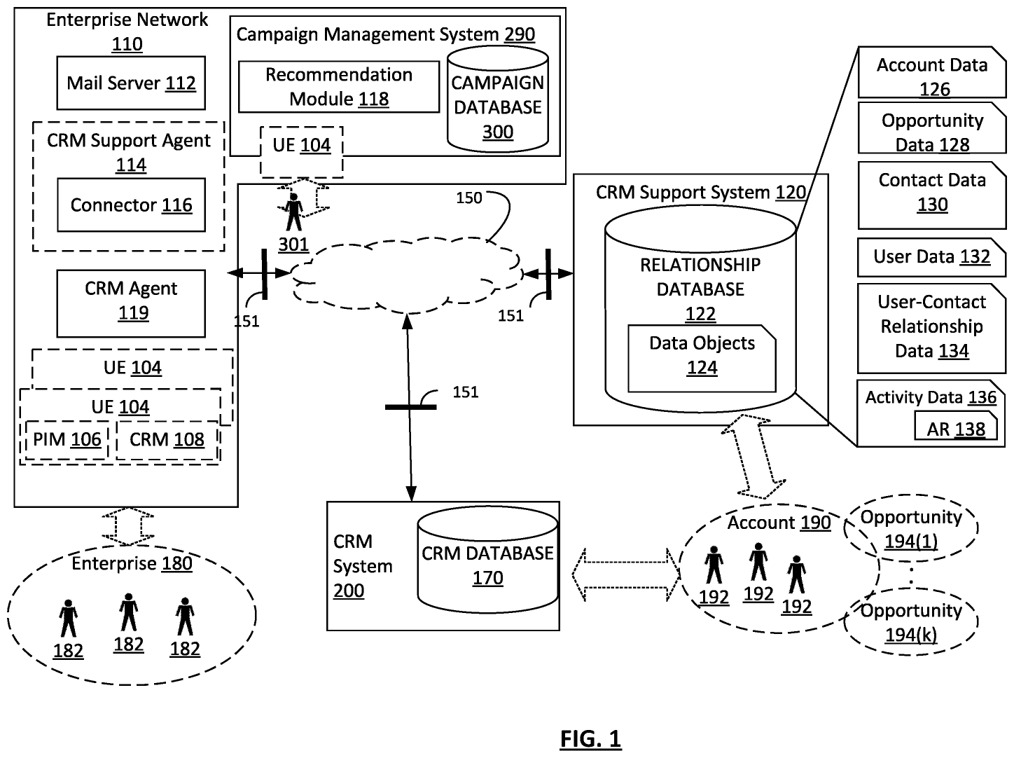

FIG. 1 illustrates an example environment in which the methods and systems described in this disclosure may be implemented. In the example of FIG. 1, environment includes an enterprise network 110 that supports an enterprise such as a company, firm or other type of organization (referred to in this disclosure as “enterprise 180”). In example embodiments, a plurality of individuals are registered or otherwise associated with the enterprise network 110 as users 182 of the enterprise 180. These individual users 182 may for example be employees, owners, partners, consultants, volunteers, and interns of the enterprise 180. In some examples, enterprise 180 could have as few as one user 182, and in some examples, enterprise 180 may have thousands or more users 182.

At any given time the enterprise 180 has, or is, pursuing commercial relationships with one or more external entities or third party organizations, referred to in this disclosure as “accounts” 190. For example, such external entities could be existing or potential customers, clients or donors or other entities of interest to the enterprise, and may include, among other things, companies, partnerships, universities, firms, government entities, joint venture groups, non-government organizations, charities and other types of groups. Typically, each account 190 will have an associated set of individual representatives or contacts, referred to in this disclosure as “contacts” 192, that are identified as contacts of the enterprise 180 in one or more electronic databases that are operated by or associated with enterprise 180. For example, the individual contacts 192 associated with an account 190 may be employees, owners, partners, consultants, volunteers, and interns of the account 190. Furthermore, at any given time the enterprise 180 will typically have completed or will be pursuing one or more opportunities 194(1) to 194(k) (with k being account dependent and representing a total number of open and closed opportunities with a specific account 190). In this disclosure, the reference “opportunity 194(j)” will be used to refer a generic individual opportunity with an account 190, and “opportunities 194” used to refer to a generic group of opportunities. An opportunity 194(j) may for example be a sales opportunity to sell a product or service, and may have an opportunity lifetime (e.g., duration of time from recognition of existence of the opportunity to closing of the opportunity) that can be divided into a set of successive stages or phases such as the seven basic stages of a sales cycle (e.g., Prospecting, Preparation, Approach, Presentation, Handling objections, Closing).

Enterprise network 110 may, for example, include a plurality of computer devices, servers and computer systems that are associated with the enterprise 180 and are linked to each other through one or more internal or external communication networks, at least some of which may implement one or more virtual private networks (VPN).

In example embodiments, the environment of FIG. 1 also includes a CRM support system 120, and a CRM system 200, each of which may also include one or more computer devices, servers and network systems. One or more of CRM support system 120 and CRM system 200 may, in some examples, be operated by third party organizations that are service providers to the enterprise 180 associated with enterprise network 110. CRM support system 120 and a CRM system 200 are configured to track customer data on behalf of enterprise 180.

In the illustrated example, enterprise network 110, CRM support system 120, and CRM system 200 are each connected to a common communication network 150. Communication network 150 may for example include the Intranet, one or more enterprise intranets, wireless wide area networks, wireless local area networks, wired networks and/or other digital data exchange networks. Respective firewalls 151 may be located between the communication network 150 and each of the enterprise network 110, CRM support system 120, and CRM system 200. In different example embodiments, one or more of the features, modules or functions of enterprise network 110, CRM support system 120, and CRM system 200 that are described herein could alternatively be implemented in common systems or systems within a common network. For example, some or all of the features or modules of one or both of CRM support system 120 and CRM system 200 could alternatively be hosted on one or more computer systems located within the enterprise network 110. Alternatively, in some examples, some or all or the agents, modules or systems included in FIG. 1 as part of enterprise network 110 could be remotely hosted (for example at CRM support system 120 or CRM system 200) and accessed by users 182 of the enterprise network 110 through network 150. The locations of various modules, engines, systems and databases as shown in FIG. 1 is illustrative of only one of many possible architecture configurations.

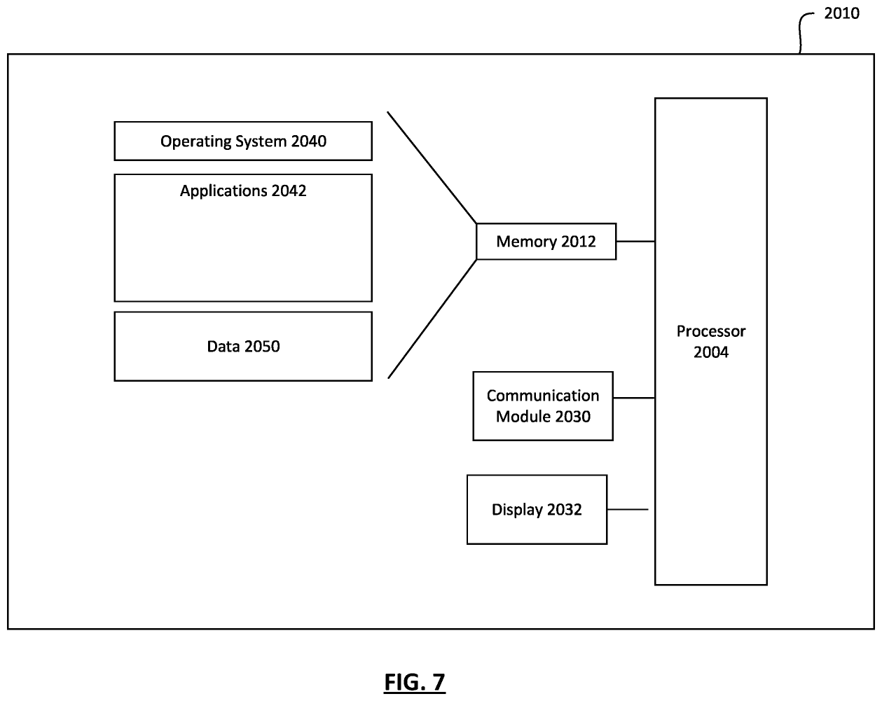

As used here, a “module” or “engine” can refer to a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit. For example, a hardware processing circuit include components of a computer system 2010 as described below in in respect of FIG. 7. A database or data storage can refer to a collection of information that is stored in an electronically accessible format using a non-transitory storage medium.

Enterprise Network 110

Enterprise network 110 includes at least one mail server 112 for handling and delivering external email that enterprise network 110 exchanges with remote mail servers through communication network 150. Thus, mail server 112 contains emails sent/received by the enterprise associated with enterprise network 110. In some examples, mail server 112 may also handle internal emails that are internal within the enterprise network 110.

In example embodiments, enterprise network 110 includes a CRM agent 119 that provides the enterprise network 110 with an interface to CRM system 200.

In example embodiments, enterprise network 110 also includes a CRM support agent 114 that provides the enterprise network 110 with an interface to CRM support system 120. In example embodiments, CRM support agent 114 includes a connector 116 that functions as an interface module between components of the enterprise network 110 and the CRM support system 120. For example, connector 116 is configured to interact with systems within the enterprise network 110 (such as mail server 112) to extract information about activities (such as communication activities) and provide that information to CRM support system 120. As described in greater detail below, connector 116 is configured to interact with systems within the enterprise network 110 (such as mail server 112 and user equipment (UE) devices 104) to extract information about activities (such as communication activities) and provide that information to CRM support system 120.

As will also be described in greater detail below, enterprise network 110 also includes a campaign management system 290 that is configured to interact with CRM support system 120 to provide, among other things, intelligent information to match contacts with marketing campaigns.

In example embodiments, enterprise network 110 supports a plurality of UE devices 104. Each enterprise user 182 is associated with one or more respective UE devices 104. In example embodiments, a UE device 104 may be a smartphone, computer tablet, laptop computer, desktop personal computer, wearable electronic device or other communication enabled computer device. In example embodiments, UE devices 104 are configured with a personal information manager (PIM) module 106. Among other things, the PIM module 106 includes an email client, as well as one or more other functions such as calendaring, task managing, contact managing, note-taking, journal logging, and web browsing functions. The PIM module 106 will typically store associated PIM data that includes, among other things, user calendar data, user address book data, user email data and user messaging data. Examples of PIM modules 106 include modules that support basic communications and scheduling services that the user of a UE device 104 is registered with, such as Google Gmail™, Microsoft Outlook Exchange Web Service, and/or Lotus Domino. In example embodiments, some or all of the PIM data associated with a user 182 may be stored locally on the UE device 104 associated with the user, and in some examples, all or parts of the PIM data may be stored at a remote server hosted by or for enterprise network 110 that is accessible through a communication network to the UE device 104. In various embodiments, some or all of the PIM data for users 182 that is stored at UE devices 104 or other remote server is accessible to CRM support agent 114. In some examples, one or more connector modules 116 are associated with CRM support agent 114 to enable the CRM support agent 114 to periodically retrieve the PIM data of registered users 182.

In example embodiments, UE devices 104 each include a CRM support client 108 that is configured to interface with the connector 116 of CRM support agent 114 to support the systems and methods described herein, including the exchange of PIM data described above. In example embodiments, a user 182 may have multiple associated UE devices 104 across which PIM data is synchronized. In some examples, a UE device 104 associated with a user could be a virtual device (e.g., a user virtual desktop) that is hosted by a server within enterprise network 110 and accessed by a remote access device (e.g., a thin client device).

In example embodiments, the CRM support client 108 of a UE device 104 has access to (or includes selected functionality of) recommendation module 118 that is configured to compute contact/campaign match recommendations as described below.

CRM System 200

In example embodiments, CRM system 200 may be implemented using a known CRM solution such as, but not limited to, Salesforce.com™, Microsoft Dynamics™, InterAction™ or Maximizer™, and includes a CRM database 170 that includes customer data (e.g., CRM data) for accounts 190 is desirous of tracking. The CRM data that is stored in a CRM database 170 for an account 190 may for example include: (I) general account data, (II) opportunity data about specific opportunities that the enterprise has undertaken in the past, is currently undertaking, or is proposing to undertake in the future with accounts 190, and (III) individual contact data that includes contact information for individual contacts who are members of the accounts 190.

CRM Support System 120

In example embodiments, CRM support system 120 is configured to provide enhanced CRM information and functionality that supplements CRM System 200. CRM support system 120 includes a relationship database 122 for storing relationship data generated in respect of the accounts 190 of interest to enterprise 180. In example embodiments, similar to CRM database 170, relationship database 122 may store, in respect of each account 190 (e.g. each customer or client of enterprise 180), relationship data objects 124 that include: (I) account data 126 that provide general information about the account 190, (II) opportunity data 128 about specific opportunities that the enterprise has undertaken in the past, is currently undertaking, or is proposing to undertake in the future with the account 190, (III) individual contact data 130 that includes contact information for individual contacts 192 (e.g., employees) who are associated with the account 190, (IV) user data 132, that includes information about enterprise users 182 who are involved in the relationship with an account 190, (V) user-contact relationship strength data 134, and (VI) activity data 136 that includes information about activities between enterprise 180 and account 190. The data in relationship database 122 may include some or all of the information stored at CRM database 170, as well as supplemental information.

In example embodiments, the CRM Support System 120 interfaces with connector 116 of CRM support agent 114 and other possible data sources to collect and update of data stored in relationship database 122. In some examples, the CRM support system 120 is configured to periodically refresh (e.g., for example on a timed cycle such as once every 24 hours) the content of data objects 124 such that the data maintained in relationship database 122 always includes current or near-current information. The CRM support system 120 may periodically refresh the information stored in relationship database 122 based on information from a plurality of sources. For example, CRM support system 120 may obtain data from the CRM database 170 of CRM system 200, from sources within enterprise network 110, and from other data sources that are available through communication network 150.

Account data 126: In example embodiments, the basic data included in account data 126 stored at relationship database 122 may include, for each account 190, some or all of the fields listed in the following Table 1, among other things:

TABLE 1
Account Data Fields:

| Field | Field Description |
|---|---|
| Enterprise ID | Unique identifier assigned to |
| | Enterprise 180 |
| Account ID | Unique identifier assigned to |
| | Account 190 |
| Account Industry Code | Code that identifies primary industry |
| | type of customer organization (e.g., |
| | Standard Industrial Classification |
| | (SIC) Code and/or North American |
| | Industry Classification System |
| | (NAICS) Codes) |
| Number of Employees | Number of Employees of Account |
| | Organization |
| Account Size Score | Score assigned based on size of |
| | account organization (e.g., |
| | organization size of 1500+ |
| | employees = 10 points; 1000 to |
| | 1500 = 9 points; 750-1000 = 8 |
| | points, etc.) |
| Account Annual Revenue | Annual Revenue of account |
| | organization for one or more |
| | previous years |
| Owner User ID | User ID of enterprise user 182 who |
| | owns the account (e.g., user 182 |
| | who has primary responsibility for |
| | enterprise-account relationship) |
| Name | Name of Account (e.g., company or |
| | organization name) |
| Top User-Account Relationship | The enterprise user 182 that has the |
| | strongest relationship with the |
| | account 190 |
| Account Status Indicator | Indicates Current Status of Accounts |
| | being targeterd (e.g., Current Active |
| | Account with Open Opportunity; |
| | Current Active Account with no Open |
| | Opportunity; Active account, |
| | Exploratory Relationship; Inactive |
| | Account; Inactive Account, prospecting) |

The fields “Account Active Indicator” can be used for an indicator that indicates if an account is currently active or is not currently active (e.g., inactive). In some embodiments, an active account is an account 190 that the enterprise 180 currently has an open opportunity with, or is a current customer or client, or has been a customer or client within a predefined prior time duration (e.g., within last year). In some examples, inactive accounts can be classified as historic accounts or prospective accounts. Inactive historic accounts may for example be previously active accounts that have been dormant (e.g., no open opportunities and currently not a current customer or client) for greater than a predefined prior time duration (e.g., more than one year). Inactive prospective accounts may for example be potential accounts that were never active but that are of interest to enterprise 180, for example organizations in an industry of interest to the enterprise 180, but whom the enterprise has not yet started prospecting.

Opportunity data 128: In example embodiments, the basic data included in opportunity data 128 stored at relationship database 122 may include, for each opportunity with each account 190, opportunity records that include some or all of the fields listed in the following Table:

TABLE 2
Opportunity Data Fields:

| Field | Field Description |
|---|---|
| Opportunity ID | Unique identifier assigned to |
| | Opportunity |
| Account ID | Account ID of the account that is the |
| | target of the opportunity |
| Created Date | Date opportunity registered with |
| | CRM support system |
| Closed Indicator | Indicates if opportunity is closed |
| Closed Date | Date Opportunity was closed |
| Current Stage | Indicates current stage of open |
| | opportunity (e.g., Prospecting, |
| | Preparation, Approach, Presentation, |
| | Handling objections, Closing) |
| Won Indicator | Indicates opportunity closed |
| | successfully (e.g., with a sale) |
| Opportunity Size Score | Score that represents a size or dollar |
| | value of the opportunity |
| Main Contact ID | Contact ID of lead contact for |
| | opportunity with the account |
| Main User ID | Contact ID of lead user for |
| | opportunity |
| Last Activity Date | Date of most recent activity |
| | recorded in respect of opportunity |
| Event ID | ID of marketing event that resulted |
| | in Opportunity (if known) |

Contact data 130: In example embodiments, the basic data included in contact data 130 stored at relationship database 122 may include, for each contact 192 at account 190, contact records that include some or all of the fields listed in the following Table 3, among other things:

TABLE 3
Contact Data Fields:

| Field | Field Description |
|---|---|
| Contact ID | Unique contact identifier |
| Active/Inactive Indicator | Indicates if contact is active or |
| | inactive |
| Date Created | Date contact added |
| Account ID | Account ID of the account the |
| | contact is associated with (referred |
| | to as “contact's account”) |
| Department | Name of department/organizational |
| | unit that contact is part of within |
| | contact's account |
| Department ID | Numerical value that maps to |
| | Department (based on pre-defined |
| | mapping rules) |
| Account Industry Code | Industry Code for contact's account |
| Position/Title | The position/title of the contact in |
| | contact's organization |
| Title Score | Hierarchal Score assigned to Contact |
| | based on contact's position at |
| | contact's organization (e.g., may be |
| | defined by a look up table that maps |
| | position titles to scores: president = |
| | 20 points, CEO = 20 points, VP = 18 |
| | points, senior manager = 14 points; |
| | partner = 16 points, etc.) |
| Contact-Enterprise Relationship | Score That Indicates Perceived |
| Score | Value of the Relationship with the |
| | Contact |
| First Name | Contact's First Name |
| Last Name | Contact's Last Name |
| Full Name | Contact's Full Name |
| Primary Email | Contact's Primary Email |
| Primary Phone | Contact's Primary Phone |
| Preferred Marketing Event | Preferred Event Type for Contact |
| Contact Origination Type | Type and ID of activity or event that |
| | caused contact to be added as an |
| | Active Contact (e.g., email |
| | communication activity, meeting |
| | communication activity, new outlook |
| | or other personal information |
| | management system contact |
| | addition) |
| Image | One or more images obtained from |
| | on-line sources (e.g., Linked-In ™ |
| | profile picture) |
| Opportunity ID(s) | ID's of opportunities that the contact |
| | is associated with |

As noted above, contacts can be indicated as active or inactive. In example embodiments, an active contact can be a contact that has been a party to an activity (as tracked in activity data 136 below) within a predefined prior time period (e.g., last 18 months) and/or meets other pre-defined criteria including for example criteria as set by privacy and solicitation legislation or regulations. Inactive contacts are contacts that are not currently active and may in some examples be classified in one or more categories such as inactive historic contacts (e.g., contacts that were previously active contacts), and inactive prospective contacts (e.g., contacts working in industries that are of interest to the enterprise or with active accounts, but who are not historic contacts).

User data 132: In example embodiments, the basic data included in user data 132 stored at relationship database 122 may include, for each user 182 that has a relationship with a contact 192 at the account 190, user records that include some or all of the fields listed in the following Table 4, among other things:

TABLE 4
User Data Fields:

| Field | Field Description |
|---|---|
| User ID | Unique user identifier |
| Account ID | Account ID of the subject account |
| Department | Name of user's department in the |
| | enterprise organization |
| Title | Title/position of user within |
| | enterprise organization |
| User-Account Relationship Score (*) | Score That Indicates Perceived |
| | Value of User's Relationship With |
| | Account |
| Opportunity ID (*) | Opportunity ID for opportunity for |
| | which user is member of the |
| | enterprise team (e.g., selling team) |

(*) indicates fields that can be repeated for multiple accounts/opportunities

User-Contact Relationship data 134: In example embodiments, the basic data included in user-contact relationship data 134 stored at relationship database 122 includes information for each known user-contact relationship that exists between a user 182 within enterprise 180 and a contact 192 within an account 190. User-contact relationship records included in user-contact relationship data 134 may, for example, include some or all of the fields listed in the following Table 5, among other things:

TABLE 5
User-Contact Relationship Data Fields:

| Field | Field Description |
|---|---|
| User ID | Unique user identifier |
| Contact ID | Contact Unique Identifier |
| Account ID | Contact's Account |
| Start Date | Date when relationship between |
| | user and contact started |
| Relationship Origination Indicator | Activity ID and/or event ID of the |
| | activity/event that first triggered |
| | Contact/user relationship |
| Active Indicator | Indicates if relationship is currently |
| | active |
| User-Contact Relationship Score | Score that indicates perceived |
| | strength of User-Contact |
| | Relationship Strength |
| Last Activity Date | Date of last recorded activity |
| | including user and contact |

Activity data 136: In example embodiments, the activity data 136 stored at relationship database 122 may include data for activities related to the entity-account relationship. Activities may for example include communication activities and documentation activities among other things. Activity data 136 may include respective activity records 138 for each logged activity. Table 6 below provides a generic example of fields that may be included in an activity record 138, depending on the type of activity and availability of information:

TABLE 6
Activity Data Fields:

| Field | Field Description |
|---|---|
| Activity ID | Unique identifier assigned to activity |
| Account ID* | Identity of Account whose contacts |
| | participated in the activity |
| Opportunity ID* | Identity of the opportunity(ies) that |
| | activity related to |
| Organizer ID | User ID of enterprise user that |
| | organized activity (e.g., email sender of |
| | meeting organizer) |
| Activity Type Indicator | Value that identifies the type of |
| | activity (e.g., (i) communication |
| | activity: incoming email, outgoing |
| | email, incoming meeting |
| | request/calendar invite, outgoing |
| | meeting request/calendar invite, |
| | incoming phone call, outgoing phone |
| | call, in-person meeting, virtual |
| | meeting, (ii) documentation activity: |
| | proposal submitted, draft statement |
| | of work (SOW) submitted; final SOW |
| | submitted; contract submitted for |
| | review). |
| Document ID | ID of document template (can be |
| | used to identify content of standard |
| | form email in the form of a |
| | communication action, or to identify |
| | document template in case of |
| | documentation activity) |
| Start Time | Date and time stamp indicating start |
| | of activity |
| Activity Duration | Duration of activity (e.g., length of |
| and/or End Time | meeting or phone call), or data and |
| | time stamp indicating end of activity |
| Sentiment Indicator | Indicator provided manually or by |
| | natural language processing |
| | algorithm as to sentiment of activity |
| | (e.g.: negative to positive sentiment |
| | on scale of 1 to 5, in example |
| | embodiments, may be determined at |
| | CRM support agent 114 and sent by |
| | connector 116 to data tracking |
| | module 122) |
| Content Count* | Counts number of occurrences of |
| | predefined words in communication |
| | activity (e.g., product name, |
| | competitor product name). (In |
| | example embodiments, may be |
| | determined at CRM support agent |
| | 114 and sent by connector 116 to |
| | data tracking module 122) |
| Participants - Account* | Contact IDs or other available identifier |
| (ID/Title/Department) | and title/department information for all |
| | individuals involved on account side |
| | who where invited |
| Participants - Enterprise* | User IDs or other available identifier |
| (ID/Title/Department) | and title/department information for all |
| | individuals involved on enterprise side |
| | of activity |
| Subject | e.g., Information included in email |
| | Subject fields or meeting “Subject” field |
| | by meeting organizer. |
| Location | e.g., Information included in meeting |
| | “Location” field by meeting organizer |
| Additional Information | Additional descriptive information about |
| | activity (e.g., information included in |
| | the open format field of a meeting |
| | scheduling form) |
| Average Enterprise-Contact | Average Enterprise-Contact |
| Relationship Score | Relationship Score of Account |
| | participants |
| Average Title Scope | Average Title score of Account |
| | participants |

*Indicates fields that will be repeated as required

Data Object Storage and Collection: In example embodiments, the CRM support system 120 includes both current and historic records in data objects 124, enabling changes in data, including data of the type included in the data object fields noted above, to be compared and plotted over time. For example, current and historical time-stamped versions of the records (or selected data fields) included as data objects 124 may be stored at relationship database 122.

The data included in data objects 124 in relationship database 122 may be obtained by CRM support system 120 from different sources using different methods. For example, some information may be collected from enterprise users 182 through data entry provided through user interfaces supported by CRM support agent 114. Some information may be gathered from third party data providers (e.g., contact information and account information pertaining to inactive prospective accounts and contacts, and supplementary information regarding contacts 192 and accounts 190). Some information may be gathered directly or indirectly (for example via CRM agent 119) from CRM system 200. Some information may be gathered through automated monitoring of enterprise network 110 activities and events, including activities at mail server 112 and UE device PIM 106 activities such as email activities, calendar activities and contact management activities. CRM support system 120 may be configured to perform periodic email, calendar and contact synchs with CRM support agent 114 for updates.

By way of example, in the case of activity data 136, in example embodiments, CRM support agent 114 is configured to automatically collect information about communication activities between users 182 associated with the enterprise 180 and external contacts 192 associated with an account 190. These communication activities may for example be electronic communications such as email, meetings that are tracked in calendar systems and/or scheduled through email communications, and telephone calls that occur through a system that enables call logging. Each of these interactions have associated electronic data that includes a contact identifier (e.g., email address or phone number for contact 192), time stamp information for the interaction, and a user identifier (e.g., data that identifies the user(s) 182 of the enterprise 180 and account contacts 192 that were involved in the communication activity).

In example embodiments, CRM support agent 114 is configured to collect the information about communication activities by interacting with devices and systems that are integrated with enterprise network 110 and generate reports that are sent to CRM support system 120 automatically on a scheduled basis or when a predetermined threshold is met or a predetermined activity occurs. In some examples, CRM support agent 114 may collect information from an enterprise mail server 112 located within enterprise network 110 and/or from PIM modules 106 associated with UE devices 104, via the connector 116.

In some examples, connector 116 may collect information from the mail server 112. For example, in some embodiments connector 116 is configured to intermittently run a batch process to retrieve email messages from the mail server 112 so that communication activity data can be derived from the email messages and provided through communication network 150 to the relationship database 122. In some examples, the connector 116 is configured to extract selected information from email messages as contact interaction data. For each email message, the extracted information may for example include any external email address included in the sender, recipient and carbon copy (CC) and blind carbon copy (BCC) recipient email address fields, along with a send or receive timestamp applied to the email message by the mail server 112. In example embodiments, the extracted information can also include information that identifies any enterprise users 182 that are participating in the email as sender or recipient or CC recipient. In example embodiments, the extracted information can also include information that identifies any account members 192 that are participating in the email as sender or recipient or CC recipient.

In example embodiments, meeting requests and invites will be included among the email messages that are processed by mail server 112, and connector 116 is configured to include email addresses in the meeting invitee list and organizer fields in the contact interaction data extracted from the emailed meeting invite. In some examples, connector 116 may also be configured to interface with CRM support clients 108 to receive data from the PIM modules 106 of UE devices 104 associated with the enterprise network 110. In some examples where enterprise network 110 supports phone call logging, for example in Voice-Over-Internet-Protocol (VOIP) implementations, connector 116 may be further configured to interact with a VOIP server to collect information about external phone numbers used for outgoing and internal calls for inclusion in communication activity data.

Relationship Scoring

It will be noted that a number of the data objects 124 include relationship scoring information that assign values to relationships based on metrics described in greater detail below. For example, relationship scores can include: account data 126 includes a “Top User-Account Relationship” that identifies the enterprise user 182 that has a highest overall relationship score with the subject account 190; contact data 130 includes a “Contact-Enterprise Relationship Score” that that indicates a perceived value of the relationship of enterprise 180 with the subject contact 192; user data 132 includes a “User-Account Relationship Score” that indicates perceived value of user's relationship with contact; and user-contact relationship data includes a “User-Contact Relationship Score” that indicates perceived strength of the user-contact relationship.

According to example embodiments, the CRM support system 120 is configured with a set of relationship score prediction models for computing each of the respective relationship scores. In at least some examples, these scores are calculated by CRM support system 120 based on communication activities between enterprise users 182 and account contacts 192, such as the communications activities that are tracked as part of activity data 136. By way of example, the user-contact relationship score for an enterprise user 182-account contact 192 could be based on a communication score that is based on features such as, among other things: activity type (e.g., incoming email, outgoing email, incoming meeting request/calendar invite, outgoing meeting request/calendar invite, incoming phone call, outgoing phone call, in-person meeting, on-line meeting, video conference); frequency (e.g., number of communication activities with a defined time period); recentness of communication activities; and length of communication activity, among other things.

By way of illustrative non-limiting example, a communication score based on frequency of communication, recentness of communication, and type of communication could be determined based on a pre-defined model or algorithm such as follows:

Raw communication score=(total number incoming emails in last week from contact listing user as direct or CC recipient)*(W1)+(total number outgoing emails in last week from user listing contact as direct or CC recipient)*(W2)+(total number of phone calls, in-person meetings, and virtual meetings involving both user and contact in last week)*(W3)+(total number incoming emails in last month from contact listing user as direct or CC recipient)*(W4)+(total number outgoing emails in last month from user listing contact as direct or CC recipient)*(W5)+(total number of phone calls, in-person meetings, and virtual meetings involving both user and contact in last month)*(W6)+(total number incoming emails in last 6 moths from contact listing user as direct or CC recipient)*(W7)+(total number outgoing emails in last six months from user listing contact as direct or CC recipient)*(W8)+(total number of phone calls, in-person meetings, and virtual meetings involving both user and contact in last week)*(W9)+(total number of all communications activities involving both user and contact over lifetime of user-contact relationship)*(W10)

Where: W1 to W2 are predetermined weights. (e.g., W1=W2=7; W3=8, W4=W5=5, W6=6; W7=W8=3; W9=4; W10=1).

In further example embodiments, the communication score may be determined using a learned model that has been learned using machine learning techniques based on historic communication and relationship data.

In example embodiments the raw communication score may be normalized to a communication score based on comparison with historical data and/or data for other user-contact relationships or other scaling methodology to a range (for example 0 to 1). In some examples, the normalization may be based on data limited to the enterprise. In some examples, the normalization may be based on data from an industry. In some examples, normalization may be related to a specific account. In some examples, a communication momentum value may be based on trends over time in the metrics represented in the raw score calculation noted above.

In some examples a User-Contact Relationship Score could be a composite of the contacts title score and a communication score based on the above attributes (e.g., contact title score*communication score). In some examples the User-Contact Relationship Score may be decided based only on the communication score. In some example embodiments, User-Contact Relationship Score could be represented as a discrete ranking within a relative scale such as “3=high”, “2=medium, “1=low”.

In some examples, “Contact-Enterprise Relationship Score” could be based on a combination (e.g., sum or product) of all of the individual User-Contact Relationship Scores that a contact 192 has with users 182 of enterprise 180. In some examples, a “User-Account Relationship Score” could be based on a combination (e.g., sum or product) of all of the individual User-Contact Relationship Scores that a user 182 has with account contacts 192. In some examples, the “Contact-Enterprise Relationship Score” could be based on a combination of all the individual User-Contact Relationship Scores across all user-contact relationships between an enterprise 180 and an account 190.

Further examples of relationship scoring techniques that can be applied are described in U.S. Pat. No. 9,633,057, issued Apr. 25, 2017, the content of which is incorporated herein by reference.

Campaign Management System 290

In example embodiments, campaign management system 290 is configured to track data about marketing campaigns of the enterprise 180 that are planned for the future and that have already occurred. In example embodiments, campaign management system 290 can assist one or more individuals that are associated with enterprise 180 (e.g., a marketing campaign creator 301) with the organization and management of a marketing campaign that includes one or more activities (also known as events) that are intended to promote a product or service.

In example embodiments, campaign management system 290 stores data about marketing campaigns in a marketing campaign database 300. The marketing campaign data for a particular marketing events may, for example, include some or all of the data fields listed in the following Table 7, among other things:

TABLE 7
Marketing Campaign Data:

| Field | Subfields/Field Description |
|---|---|
| Marketing | Unique Identifier of marketing campaign (value |
| Campaign ID | assigned by campaign management system 290 |
| | or campaign creator 301) |
| Marketing | Title given to campaign by campaign creator |
| Campaign Title | 301 |
| Campaign | Start Date of Campaign (Projected Date if |
| Start Date | Campaign is scheduled for future) |
| Campaign | End date of Campaign (Projected Date if |
| End Date | Campaign is scheduled for future or currently |
| | underway) |
| Status Indicator | Indicates if campaign is/was (1) Currently |
| | ongoing; (2) Scheduled for the future; (3) |
| | Completed; or (4) Cancelled |
| Product/Service | Identifier of product or service that campaign is |
| | intended to promote (e.g., may be a name |
| | and/or value (e.g., product SKU)) |
| Topic of Interest | Free Form field providing additional information |
| | about campaign, e.g. summary of the objective |
| | of the campaign or the ‘problem being solved’. |
| Target Contact | (1) Account Industry Code - Indicates the |
| Demographic | Industry Code(s) for a target contact's |
| Profile 302 | organization |
| | (2) Account Size - Account Size Score for a |
| | target contact's organization (in various |
| | embodiments may include a minimum value, a |
| | maximum value, and/or range) |
| | (3) Title Score - Indicates the Title Score of a |
| | targeted contact (in various embodiments may |
| | include a minimum value, a maximum value, |
| | and/or range) |
| | (4) Department Id(s) - Indicates any |
| | Department(s) that a target contacts should be |
| | a member of within their organization. |
| | (5) Contact-Enterprise Relationship Score - |
| | Indicates Target Relationship Score of contacts |
| | (in various embodiments may include a |
| | minimum value, a maximum value, and/or |
| | range) |
| | (6) Account Status Indicator - Indicates Current |
| | Status of Accounts being targeted (e.g., Current |
| | Active Account with Open Opportunity; Current |
| | Active Account with no Open Opportunity; Active |
| | account, Exploratory Relationship; Inactive |
| | Account; Inactive Account, prospecting; (each |
| | status type may be indicated by a respective |
| | predefined value) |
| | (7) Stage of Opportunity - Numeric value that |
| | indicates what stage of an open opportunity the |
| | campaign is directed towards |
| | (8) Past Campaign Engagement Indicator - |
| | Indicator that indicates if campaign targets |
| | client that have (or have not) participated in |
| | past events/marketing campaigns |
| | (9) Geographic Location(s)- Indicator of |
| | geographic location(s) of target contact |
| Campaign | List of Contacts that are participating in the |
| Participant | campaign. Contacts are each identified in the list |
| List 306 | by Unique Identifiers (Unique Identifiers may for |
| | example include one or more of invitee name, |
| | invitee email, Contact ID (if known), or other |
| | identifier than can be cross referenced or |
| | mapped to unique identifying information for |
| | contacts that are recorded in relationship |
| | database 122 and/or CRM database 170.) Each |
| | Unique Identifier can also be associated with a |
| | time stamp indicating date/time the contact was |
| | added to the campaign participant list. |
| Activity ID(s) | Unique Activity ID(s) that is assigned to an |
| | activity that is associated with the marketing |
| | campaign. |

A marketing campaign will typically include one or more activities that target contacts can be participate in or be otherwise targeted by. As indicated in Table 7, each of these activities is assigned a unique activity ID. In example embodiments, each activity ID maps to a respective marketing campaign activity record stored in campaign database 300. The marketing campaign activity record for a particular activity may, for example, include some or all of the data fields listed in the following Table 8, among other things:

TABLE 8
Marketing Campaign Activity Records:

| | |
|---|---|
| Marketing | Unique Identifier of marketing campaign that |
| Campaign ID | activity is part of |
| Activity ID | Unique Activity ID assigned to the activity |
| Activity Type ID | Value that indicates a Activity type or category: |
| | Trade Show |
| | Conference |
| | Webinar |
| | Physical Mail Out |
| | Open House |
| | Wine'n'Cheese |
| | Lunch'n'Learn |
| | Breakfast Briefing |
| | Round Table |
| | Promotional Give-away |
| | Email Mail out |
| Activity Date | Date/Time of the Activity (or range of dates if |
| | Activity continues over time) |
| Activity Location | Location of Activity: |
| | Virtual Conference |
| | Audio Conference |
| | Location of Physical meeting |
| Invitation Date | If activity requires an invitation, date or range |
| | of dates during which activity invitations were |
| | distributed (e.g., by email or social media) |
| Activity Cost | Total monetary cost of the activity (Can be |
| | broken into subcategories) |
| Activity Coordinator | ID of enterprise User responsible for activity |
| Activity Invitees | List of target contacts that were invited to an |
| | activity that required an invitation. Invitees are |
| | each identified in the list by Unique Identifiers |
| | (Unique Identifiers may for example include one |
| | or more of invitee name, invitee email, Contact |
| | ID (if known), or other identifier than can be |
| | cross referenced or mapped to unique |
| | identifying information for contacts that are |
| | recorded in relationship database 122 and/or |
| | CRM database 170.) Each Unique Identifier can |
| | also be associated with a time stamp indicating |
| | date/time the invitation was provided and a |
| | invitation medium identifier indicating how the |
| | invitation was provided (e.g., by email, through |
| | social media, by regular email, in-person.) |
| Activity Participants | List of Unique Identifiers for target contacts |
| | who are known to have participated in the |
| | activity (for example responded to an invite, |
| | signed up through a web-interface, or other |
| | conformation mechanism). Each Unique |
| | Identifier can also be associated with a time |
| | stamp indicating date/time of confirmation and |
| | an indication of type of confirmation. the |
| | registration occurred and a registration medium |
| | identifier indicating how participation was |
| Total number of | Total number of Contacts Invited for activity |
| Invitees | |
| Total number of | Total number of Contacts who participated in |
| Participants | activity |
| Current Account | Current Status of Accounts being targeted (e.g., |
| Status | Current Account, Open Opportunity, Currently |
| | not an Open Opportunity, Exploratory |
| | Relationship) |
| Stage of Opportunity | If the Current Account Status is ‘Open |
| | Opportunity’ then this field identifies the |
| | targeted stage of the opportunity |
| Attended Past Events | Identifies if the event is targeting contacts that |
| | have, or have not, attended a past marketing |
| | event |

In some examples, campaign management system 290 may be configured to interface with one or more of the databases and data storages of enterprise network 110, CRM support system 120 and CRM system 200 to exchange information about the fields included in the above tables.

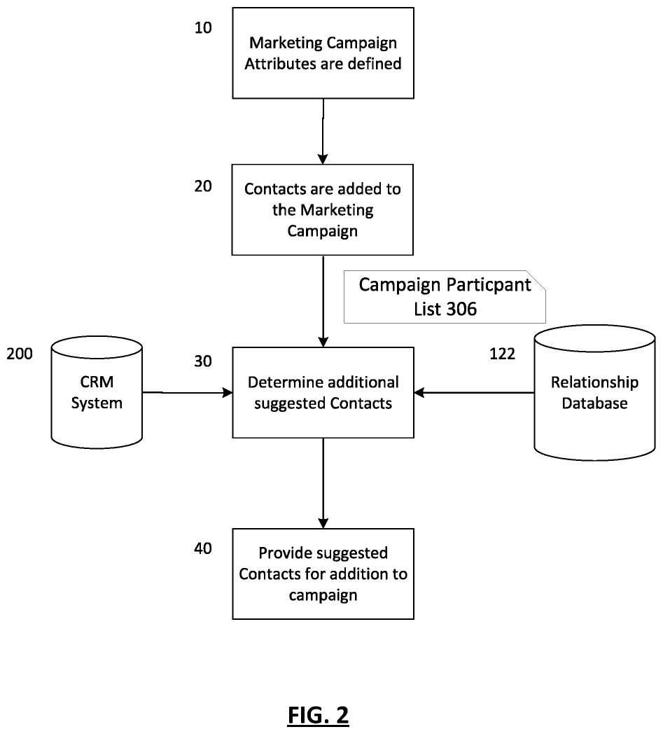

In example embodiments, the campaign management system 290 is configured to assist a campaign creator 301 with the configuration and setup and ongoing management of a marketing campaign. In this regard, FIG. 2 illustrates an interactive process that is undertaken during creation of a marketing campaign. In an example embodiment, the campaign management system 290 includes an interface that enables a campaign creator 301 to access the functionality described below through a UE device 104.

As indicated at step 10, a set of marketing campaign attributes are defined. In an example embodiment, as part of step 10, the campaign management system 290 is configured to present one or more interactive user interface forms on a display of a UE device 104 and receive user inputs through the UE device 104 in order to enable the campaign creator 301 to provide some or all of marketing campaign attributes for a proposed marketing campaign. These attributes may for example include at least some of the data required to populate the fields shown in marketing campaign Table 7 above and marketing campaign activity Table 8 above.

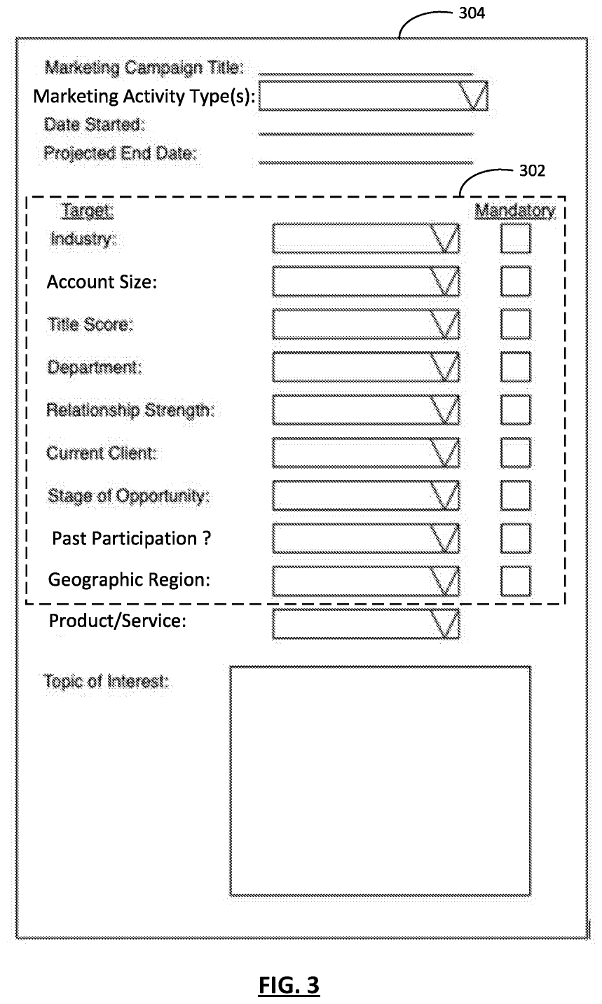

In this regard, FIG. 3 illustrates an example interface form 304 through which the campaign creator 301 may enter marketing campaign attributes for a future marketing campaign. As illustrated in FIG. 3, some attributes may be provided through text entry (e.g., Marketing Campaign Title), and some may be entered through lists of defined options. In the case of defined options, the campaign creator 301 would select, from a drop-down menu system, the appropriate values for attributes. In some cases (for example, account size, title score, and relationship strength size) the selection options could be a minimum value, in some cases the selection options could be limited to a maximum value, and in some cases a minimum and maximum value of a range may be specified. In some examples, multiple alternative values may be provided for an attribute (for example, multiple industry type codes and multiple department codes may be targeted by a campaign). In some examples, if a particular attribute is not targeted, or the campaign creator has no preference, then the fields can be left blank and that attribute will be ignored in future analysis. As noted in FIG. 3, some input fields in form 304 include an adjacent “mandatory” checkbox. In this regard, the campaign creator 301 has the option to identify an attribute as mandatory (ensuring that all attending contacts must meet that attribute without exception).

In FIG. 3, a dashed line is located around a set of attributes that correspond to a Target Contact Demographic Profile 302. Further information about the Target Contact Demographic Profile 302 is shown in Table 7 above. The Target Contact Demographic Profile 302 represents what the target attributes of the model contact that the campaign creator 301 is targeting the campaign towards.

As shown in FIG. 3, interface form 304 includes a “Marketing Activity Type(s)” field that enables a campaign creator 301 to select an activity type from a drop down menu. In example embodiments, when a campaign creator 301 selects a specific activity type (e.g., breakfast meeting), the campaign management system 290 is configured to present a further interactive from (e.g. An “Activity Planner” form) to allow the campaign creator 301 to add details about a planned marketing activity to the marketing campaign. For example, the Activity Planner form could prompt the campaign creator 301 to enter attributes that correspond to at least some of the fields of Activity Table 8. In example embodiments, interface form 304 allows multiple marketing activities (and corresponding marketing activity records) to be created for and associated with a particular marketing campaign.

The campaign management system 290 is configured to store the marketing campaign data that is received in Step 10 as marketing campaign data in a marketing campaign database 300. For example, the marketing campaign data for a marketing campaign may include records that include the information shown in tables 7 and 8. In some examples, campaign management system 290 is configured to periodically interface with CRM support system 120 to acquire and or update information for marketing campaign data that is available in CRM support system 120.

As indicated in step 20, in example embodiments the event management system 290 presents a user interface form that facilitates entry by the marketing campaign creator 301 of a list of key target contacts for the marketing campaign. In some examples the marketing campaign creator 301 may generate contacts for inclusion in a campaign participant list 306 based on a search conducted of contacts data 130 using manually defined search criteria and/or based on the marketing campaign creator 301 personal knowledge and experience of who should be included in a marking campaign. The marketing campaign creator 301 may for example search in one or more databases for contacts associated with specific accounts, or based on information received from business development teams, or sales resources.

In example embodiments, campaign management system 290 includes a recommendation module 118 that is configured to identify additional potential target contacts to add to the marketing campaign. In example embodiments, in step 30 the recommendation module is configured to match contacts that are identified in available databases (for example relationship database 122) based on Target Contact Demographic Profile 302 identified in step 10. In example embodiments, the Target Contact Demographic Profile 302 may be used in step 30 to perform multiple filtering stages as follows:

Step A: Build Target Contact Feature Vector: In an example embodiment, recommendation module 118 builds a Target Contact Feature Vector that is based on the Non-Mandatory Target Contact Attributes that are specified in Target Contact Demographic Profile 302. For example industry and geographic region may have been identified in step 10 by the campaign creator 301 as Mandatory Target Contact Attributes. The remaining target attributes for which values have been specified are deemed Non-Mandatory Target Contact Attributes and used to build a multi-dimensional Target Contact Feature Vector that represents a target contact. For example, in the case where all remaining fields in the Target Contact Demographic Profile 302 have been populated, and industry and geographic region have been identified Mandatory Target Contact Attributes, the Target Contact Feature Vector will comprise a set of seven variables that each respectively represent the following: (account size; title score; department; relationship strength; current client indicator; stage of opportunity; past participation). In example embodiments, each of these values are mapped to numeric values using a predefined mapping rules and respectively normalized to a value between 0 and 1. In some examples, where multiple discrete values have been specified as possible alternatives, (e.g., a plurality of different target departments), recommendation module 118 may be configured to builds a respective Target Contact Feature Vector for each of the alternative options. Accordingly, the output of Step A is a Target Contact Feature Vector set that includes one or more Target Contact Feature Vectors. In example embodiments, attributes that are not populated in step 10 (i.e., left blank) are not included as dimensions in the Target Contact Feature Vector(s).

Step B: Filtering based on Mandatory Target Contact Attributes: As a first filtering step, recommendation module 118 retrieves contact information for contacts that are included in contact data 130 (or CRM system 200 in some embodiments if not all relevant contact data is replicated in relationship database 122) based on the Mandatory Target Contact Attributes (as indicated by the campaign creator in step 10) included in Target Contact Demographic Profile 302. Accordingly, the first round of filtering will limit potential contacts to those contacts that are identified in relationship database 122 as having attributes (as specified, for example, in contacts data 130) that meet the criteria specified in the Mandatory Target Contact Attributes. By way of example, taking the above mentioned example where industry and geographic region are mandatory fields, any contacts that are in organizations that do not fall within the target industry and geographic region will be excluded from further consideration.

Step C: In example embodiments, recommendation module 118 is configured to create respective candidate contact feature vectors for each of the contacts that are not eliminated in Step B. The same attributes are included in the respective candidate contact feature vectors as are included in the Target Contact Feature Vector(s). The values for these attributes may for example be based on information included in relationship database 122.

Step D: In example embodiments, recommendation module 118 applies a further round of filtering by applying a similarity model. In particular, the recommendation module 118 is configured to identify, based on the candidate contact feature vectors, the candidate contacts having feature vectors that are sufficiently similar to the Target Contact Feature Vector(s) to justify adding the candidate contacts to the campaign participant list 306. The similarity comparison applied by a similarity model may be done using different analytical techniques in different example embodiments. For example, each Target Contact Feature Vector may be deemed an origin point in a multidimensional feature space that include dimensions for each of the values included in the Target Contact Feature Vector. The candidate contact feature vectors can be plotted relative to the origin, and the contacts selected based on their respective Euclidian distances to the origin. For example, up to a specified number of contacts that are within a maximum distance of the origin may be selected as sufficiently similar to deem a match for a marketing campaign and add to the campaign participant list 306. Other matching procedures based on comparison models that use machine learning clustering techniques (such as but not limited to: K-means clustering or hierarchical clustering) may also be used to determine if a contact should be suggested to be added to the marketing campaign.

In some examples, weighting may be applied to the different dimensional values included in the contact feature vectors to weight a perceived relative importance of the respective attributes in determining similarity. In some examples, these weight parameters may have default values that can be adjusted by the campaign creator 301. In some examples, machine learning based models may be trained to learn weights based on training data.

As indicated in step 40, in example embodiments the recommendation module 118 is configured to provide the campaign creator 301 with an interface that includes a list of suggested contacts that matched in step 30. Based on inputs from the campaign creator 301, the additional contacts are selectively added to or excluded from the campaign participant list 306, which is stored in campaign database 300 for future reference during the campaign. In some examples, additions may be made automatically to campaign participant list 306 without requesting conformation from the campaign creator 301.

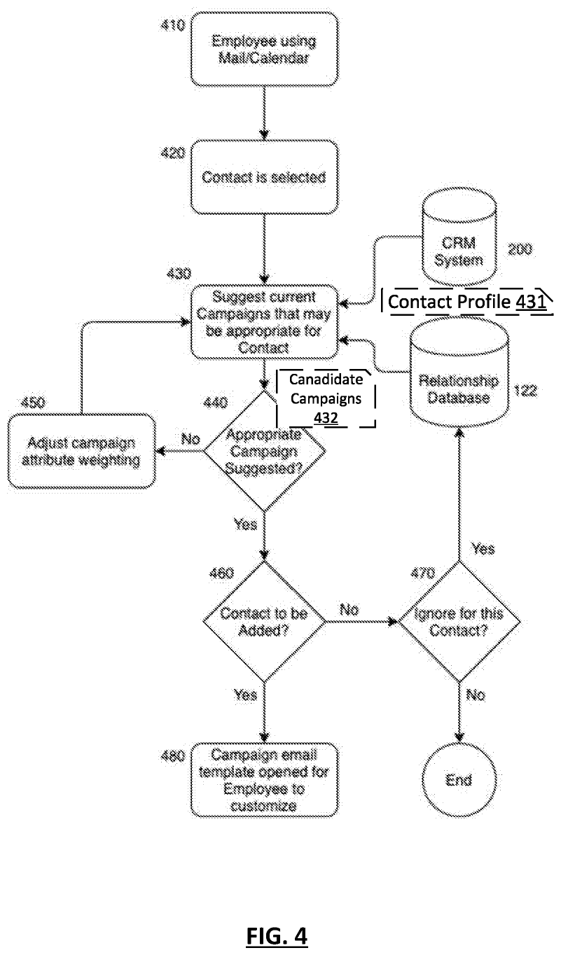

FIG. 4 illustrates an example of a contact specific campaign recommendation process. In example embodiments users 182 are given the opportunity to interface with event management system 290 to identify ongoing marketing campaigns that may be suitable for specific contacts that they know or have a relationship with. In example embodiments, the CRM support client 108 on a user's UE device 104 enables the user 182 to interact with the campaign management system and recommendation module 118 as follows.

As indicated in step 410, in an example embodiment a user 182 is able to trigger the campaign recommendation process in respect of a particular contact 192. For example, an email or calendar function of the PIM module 106 may include a software add-on or plug-in that enables a user 182 to request a marketing campaign suggestion for a person that is identified by an email address in an email to or cc field, or the invitee field of a calendar invite (Step 420). Other methods may be provided for a user 182 to trigger the campaign recommendation process, including for example a panel display generated by CRM support client 108 that includes a suitable interface that allows a contact identifier to be inputted.

As indicated in step 430, the recommendation module 118 is configured to retrieve information on the identified contact from the Relationship Database 170 (and, if not all relevant information has been replicated in relationship database, then from other sources such as one or more of the CRM System 200). By way of example, an email address can be correlated to a contact record included in contact data 130, allowing information to be retrieved from relationship database 122 to build a subject contact profile 431 for the identified contact that includes information similar to or the same as the information included in the Target Contact Demographic Profiles 302 of the marketing campaigns that are stored in campaign database 300. Recommendation module 118 is also configured to access data about existing, and in some examples historic, marketing campaigns stored in campaign database 300, including the Target Contact Demographic Profiles 302. In examples embodiments, the recommendation module is configured to compare information from the subject contact profile 431 to the Target Contact Demographic Profiles 302 to determine possible marketing campaign matches for the subject contact. The comparison may be as follows:

Step A: In an example embodiment, the recommendation module 118 may perform an initial filtering step based on Mandatory Target Contact Attributes to eliminate some potential marketing campaigns. In this regard, a first round of filtering will limit candidate marketing campaigns to those that have Mandatory Target Contact Attributes that do not eliminate the subject contact. If the Mandatory Target Contact Attributes included in the Target Contact Demographic Profile 302 associated with a specific marketing campaign specify values that exclude the subject contact profile 431, then that specific marketing campaign is excluded from further consideration and more particularly is excluded from a set 432 of candidate marketing campaigns that proceeds to a second round of filtering.

Step B: In example embodiments, as a precursor to a second round of filtering, the recommendation module 118 is configured to build a subject contact feature vector that is based on the attributes specified in Target Contact Demographic Profile 302. For example, the subject contact feature vector will comprise a set of nine variables that each respectively represent the following: (industry; account size; title score; department; relationship strength; current client indicator; stage of opportunity; past participation; geographic location). In example embodiments, the recommendation module 118 is configured to build similar Target Contact Feature Vectors for each of the campaigns that are included in the set 432 of candidate marketing campaigns (as noted above, in some examples multiple Target Contact Feature Vectors may be required for some campaigns that specify multiple discrete values for one or more fields such as “Department” and “Stage of Opportunity”). In examples of where no target attribute has been specified in respect of a campaign, the corresponding value included in the subject contact feature vector may be used in the Target Contact Feature Vector for that attribute.

Step C: In example embodiments, recommendation module 118 applies a further round of filtering by applying a similarity model. In particular, the recommendation module 118 is configured to identify, based on the Target Contact Feature Vectors, the candidate marketing campaigns that have target contact profiles that are similar enough to the profile of the subject contact to justify keeping the marketing campaign in the set 432 of candidate marketing campaigns for further consideration. For example the Euclidian distances of each of the Target Contact Feature Vectors from the subject contact feature vector may be used as a measure of similarity. For example, up to a specified number of Target Contact Feature Vectors that are within a maximum distance of the subject contact feature vector may be selected as sufficiently similar to deem a match. The campaigns that correspond to the selected Target Contact Feature Vectors will be retained in the set 432 of candidate marketing campaigns, and other candidate campaigns removed. In example embodiments, the similarity/distance criteria used to determine a match in step 430 is different than that in step 30, allowing a larger number of possible matches to occur. For example the maximum distance may be greater. This allows contacts that were not matched in step 30 to be matched in step 430.

Other matching procedures based on comparison models that use machine learning clustering techniques (such as but not limited to: K-means clustering or hierarchical clustering, or K-mode clustering utilizing hemming distance) may also be used to determine if a marketing campaign should be recommended for a subject contact. In some examples, weighting may be applied to the different dimensional values included in the contact feature vectors to weight a perceived relative importance of the respective attributes in determining similarity. In some examples, machine learning based models may be trained to learn weights based on training data. In some examples, training data can be obtained from historic marketing campaign data for completed campaigns.

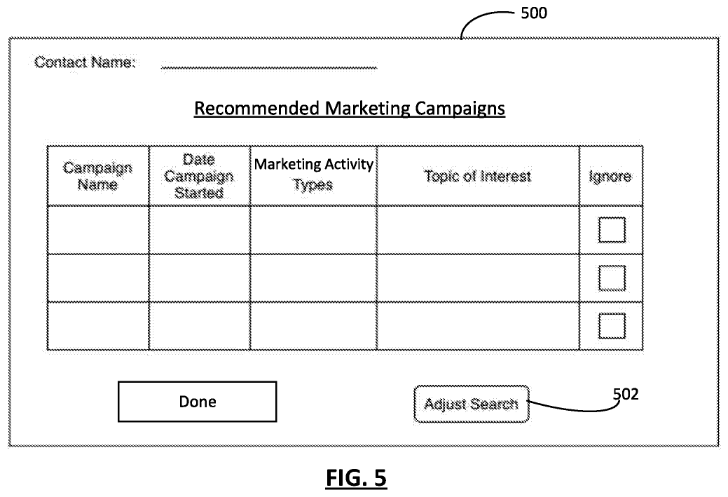

Referring to step 440, in example embodiments the set 432 of candidate campaigns is presented through an interactive user interface form 500 that may be generated on a display of UE device 104. FIG. 5 shows an example of a user interface form 500 that may be used to present the names and other information about the campaigns included in the set 432 of candidate campaigns. In example embodiments, user interface form 500 incudes user selectable options for excluding or including the campaigns included in the set 432 (shown as user selectable “ignore” option in FIG. 5). Thus, enterprise user 182 can review the suggested marketing campaigns and, based on their knowledge of the contact, decide if there is one or more suggested marketing campaigns that would be a good campaign to add the subject contact to. As shown in FIG. 5, supplemental informational attributes that are included in the data for a marketing campaign but not considered as part of the Target Contact Demographic Profile 302 may be included in the displayed information, such as the campaign start date, types of campaign activities, and information from the “topic of interest” field.

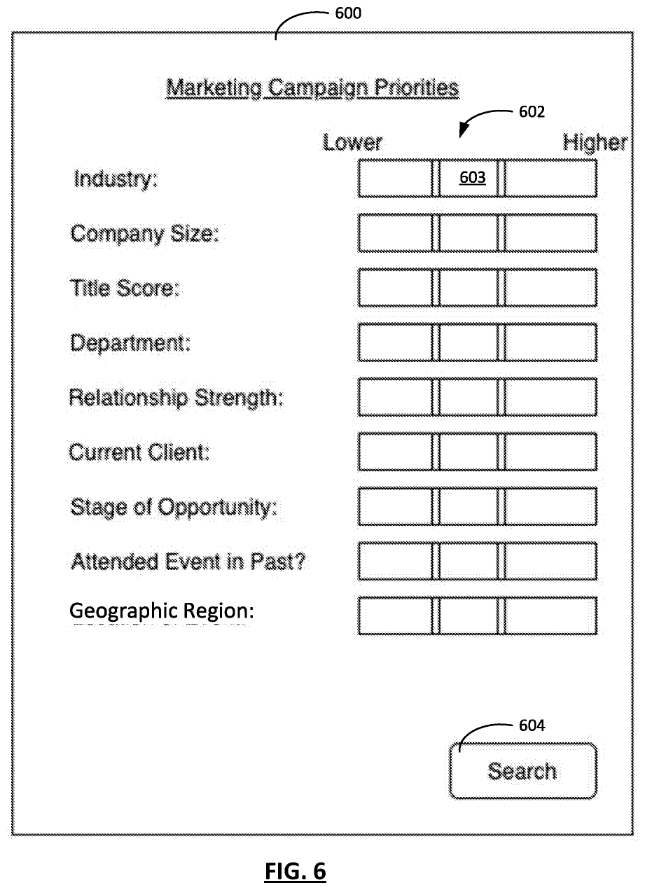

With reference to Step 450, in example embodiments, if the enterprise user 182 does not receive a suggested marketing campaign, or does not receive acceptable marketing campaign suggestions, then the enterprise user is provided with a user selectable option to adjust the search or filtering parameters. By way of example, as shown in FIG. 5, the form 500 may include a user selectable “Adjust Search” option 502. When user selection of the “Adjust Search” option 502 is detected, a further interactive user interface form 600 is presented on the display of UE device 104, as illustrated in FIG. 6. User interface form 600 that allows the enterprise user 182 to adjust weighting values for each of marketing campaign attributes included in the subject feature vector. By way of example, user interface form 600 includes a plurality of virtual sliders 602, each including a slid indicator 603, that can be moved towards a “lower” position” and a “higher position”. When the user 182 selects a “search” option, Step C of step 430 is repeated, with the relative weights applied to the respective feature vector values being adjusted accordingly. Accordingly, a user 182 may adjust the search criteria weighting of the marketing campaign attributes. The adjustment to the attributes weights does not permanently impact any of the machine learning models that may have been used in Step 430, but are temporary changes utilized for one search only.

Referring again to 440 and FIG. 5, a user can selected a “done” option when they have completed searching. Selection of the Done button indicates the user 182 will not be making any further changes to the campaigns that remain included in the set 432 of candidate campaigns. The completed set 432 of candidate campaigns provides a list of campaigns that the user wants to add the contact to (and in some examples, specifically wants to ignore for the contact). As indicated in step 470, in some example embodiments where a campaign has been identified as a campaign to ignore, this information may be recorded in one or both of the marketing campaign database 300 and/or contact data 130 so as to indicate that this campaign should not be suggested for the subject contact in the future.

As indicated in steps 460 and 480, in the event that completed set 432 of candidate campaigns includes one or more candidate campaigns 432 that the user 182 has decided the contact should be added to, then in some examples the user is provided with an option to send a request to add the contact to the campaign creator 301, and/or to send an email to the contact asking if they would like to be added to the campaign. For example, in one embodiment, the enterprise user 182 will be presented with an email template for the suggested marketing campaign(s) and can complete the template and send the invitation to the contact. In an alternate embodiment, the enterprise user 182 will select the contact for inclusion in a suggested marketing campaign and the campaign creator will be notified to add the contact to the campaign. In another alternate embodiment, the enterprise user 182 will be presented with an information package on the suggested marketing campaign(s) and can then review this information with their contact in the appropriate medium (such as but not limited to, an email, a phone call, or a video conference).

In some example embodiments, the contact and campaign information will be provided from the UE 104 to the recommendation module 118, which will automatically add the subject contact to the participant lists(s) 306 for the identified campaigns.

Referring to FIG. 7, an example embodiment of a computer system 2010 for implementing one or more of the modules, systems and agents included in enterprise network 110, CRM system 200, and CRM support system 120 will be described. In example embodiments, computer system 2010 may be a computer server. The system 2010 comprises at least one processor 2004 which controls the overall operation of the system 2010. The processor 2004 is coupled to a plurality of components via a communication bus (not shown) which provides a communication path between the components and the processor 2004. The system comprises memories 2012 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory. The system 2010 includes a communication module 2030.

The communication module 2030 may comprise any combination of a long-range wireless communication module, a short-range wireless communication module, or a wired communication module (e.g., Ethernet or the like) to facilitate communication through communication network 150.

Operating system software 2040 executed by the processor 2004 may be stored in the persistent memory of memories 2012. A number of applications 2042 executed by the processor 2004 are also stored in the persistent memory. The applications 2042 can include software instructions for implementing the systems, methods, agents and modules described above (including for example recommendation module 118).

The system 2010 is configured to store data that may include data objects 124 in the case of CRM support system 120 and the campaign data of campaign database 300 in the case of campaign management system 290. The system 2010 may include an interactive display 2032 and other human I/O interfaces in the case of UE device 104.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

What is claimed is:

1. A computer implemented method comprising:
storing campaign data for a marketing campaign that includes one or more marketing activities, the campaign data including a target contact demographic profile that defines a set of target attributes in respect of a target contact for the campaign;
retrieving, from a database, contact data for a plurality of contacts, the contact data for each of the contacts including contact attributes of the same type that are included in the set of target attributes;
computing, based on a comparison of the set of target attributes and the contact attributes for the plurality of contacts, a subset of the contacts suitable for the marketing campaign; and
storing information identifying the subset of contacts in a participant list for the marketing campaign.

2. The method of claim 1 wherein the set of target attributes includes one or more attributes that are mandatory target attributes and a subset of target attributes that are non-mandatory target attributes, wherein computing the subset of the contacts suitable for the marketing campaign comprises:
determining a target contact feature vector that includes respective values representing the non-mandatory target attributes;
filtering contacts identified in the retrieved contact data to exclude contacts that do not meet criteria specified by the one or more mandatory target attributes;
determining, for each of the remaining contacts, a respective candidate contact feature vector that incudes values for attributes that are the same type as the non-mandatory target attributes; and
selecting, based on comparison of the respective candidate contact feature vectors with the target contact feature vector, one or more of the remaining contacts to include in the subset of the contacts suitable for the marketing campaign.

3. The method of claim 2 comprising receiving user input indicating the mandatory target attributes.

4. The method of claim 2 wherein selecting the one or more of the remaining contacts to include in the subset of the contacts suitable for the marketing campaign comprises: computing a relative distance of each of the respective candidate contact feature vectors to the target contact feature vector within a feature space, and selecting contacts whose respective candidate contact feature vectors fall within a defined distance criteria.

5. The method of claim 1 wherein the set of target attributes includes attributes that represent one or more of: a type of industry; size of contact's organization; a title score that is indicative of contact's position in contact's organization; a department identifier that identifies an organizational unit that a contact is a member of; a relationship score that indicates a perceived value of of a relationship with a contact; and a geographic location.

6. The method of claim 1 wherein the method further comprises:
retrieving, from the database, contact data for a subject contact, the contact data for the subject contact including a set of subject contact attributes;
retrieving, the stored campaign data for a plurality of marketing campaigns, the stored campaign data including the set of target attributes for each of the marketing campaigns;
computing, based on a comparison of the set of target attributes for the plurality of marketing campaigns, a subset of the marketing campaigns that are suitable for the subject contact; and
presenting information identifying the subset of the marketing campaigns.

7. The method of claim 6 wherein computing the subset of the marketing campaigns suitable for the subject contact comprises:
filtering the plurality of marketing campaigns to exclude marketing campaigns for which the subject contact does not meet criteria specified by one or more mandatory target attributes;
determining for the subject contact a subject contact feature vector including values for the subject contact attributes;
determining, for each of the remaining marketing campaigns, a respective target contact feature vector that incudes values for attributes that are the same type as the subject contact attributes; and
selecting, based on comparison of the respective target contact feature vectors with the subject contact feature vector, one or more of the remaining marketing events to include in the subset of the marketing campaigns.

8. The method of claim 7 wherein the comparison of the respective target contact feature vectors with the subject contact feature vector is based on weighting values, the method comprising receiving user input to adjust one or more of the weighting values and then re-selecting, based on a further comparison of the respective target contact feature vectors with the subject contact feature vector based on the adjusted weighting values, one or more of the remaining marketing events to include in the subset of the marketing campaigns.

9. A system for matching marketing campaigns and contacts, the system comprising a processor and non-transitory storage medium coupled to the processor, the storage medium storing software instructions that when executed by the processor configure the system to:
store campaign data for a marketing campaign that includes one or more marketing activities, the campaign data including a target contact demographic profile that defines a set of target attributes in respect of a target contact for the campaign;
retrieve, from a database, contact data for a plurality of contacts, the contact data for each of the contacts including contact attributes of the same type that are included in the set of target attributes;
compute, based on a comparison of the set of target attributes and the contact attributes for the plurality of contacts, a subset of the contacts suitable for the marketing campaign; and
store information identifying the subset of contacts in a participant list for the marketing campaign.

10. The system of claim 9 wherein the set of target attributes includes one or more attributes that are mandatory target attributes and a subset of target attributes that are non-mandatory target attributes, wherein the subset of the contacts suitable for the marketing campaign is computed by:
determining a target contact feature vector that includes respective values representing the non-mandatory target attributes;
filtering contacts identified in the retrieved contact data to exclude contacts that do not meet criteria specified by the one or more mandatory target attributes;
determining, for each of the remaining contacts, a respective candidate contact feature vector that incudes values for attributes that are the same type as the non-mandatory target attributes; and
selecting, based on comparison of the respective candidate contact feature vectors with the target contact feature vector, one or more of the remaining contacts to include in the subset of the contacts suitable for the marketing campaign.

11. The system of claim 10, wherein the system is configured to receive user input indicating the mandatory target attributes.

12. The system of claim 10 wherein the one or more of the remaining contacts to include in the subset of the contacts suitable for the marketing campaign is selected by: computing a relative distance of each of the respective candidate contact feature vectors to the target contact feature vector within a feature space, and selecting contacts whose respective candidate contact feature vectors fall within a defined distance criteria.

13. The system of claim 9 wherein the set of target attributes includes attributes that represent one or more of: a type of industry; size of contact's organization; a title score that is indicative of contact's position in contact's organization; a department identifier that identifies an organizational unit that a contact is a member of; a relationship score that indicates a perceived value of of a relationship with a contact; and a geographic location.

14. The system of claim 9 wherein the system if further configured to:
retrieve, from the database, contact data for a subject contact, the contact data for the subject contact including a set of subject contact attributes;
retrieve, the stored campaign data for a plurality of marketing campaigns, the stored campaign data including the set of target attributes for each of the marketing campaigns;
compute, based on a comparison of the set of target attributes for the plurality of marketing campaigns, a subset of the marketing campaigns that are suitable for the subject contact; and
present information identifying the subset of the marketing campaigns.

15. The system of claim 14 wherein the subset of the marketing campaigns suitable for the subject contact is computed by:
filtering the plurality of marketing campaigns to exclude marketing campaigns for which the subject contact does not meet criteria specified by one or more mandatory target attributes;
determining for the subject contact a subject contact feature vector including values for the subject contact attributes;
determining, for each of the remaining marketing campaigns, a respective target contact feature vector that incudes values for attributes that are the same type as the subject contact attributes; and
selecting, based on comparison of the respective target contact feature vectors with the subject contact feature vector, one or more of the remaining marketing events to include in the subset of the marketing campaigns.

16. The system of claim 15 wherein the comparison of the respective target contact feature vectors with the subject contact feature vector is based on weighting values, the system being configured to receive user input to adjust one or more of the weighting values and then re-select, based on a further comparison of the respective target contact feature vectors with the subject contact feature vector based on the adjusted weighting values, one or more of the remaining marketing events to include in the subset of the marketing campaigns.
